(19) United States
(12) Patent Application Publication
(10) Pub. No.: US 2013/0174971 A1
(43) Pub. Date: Jul. 11, 2013

(54) METHOD FOR MANUFACTURING SADDLES AND THE LIKE

(71) Applicant: Luca Cassani, Castelcucco (IT)

(72) Inventor: Luca Cassani, Castelcucco (IT)

(21) Appl. No.: 13/823,169

(22) PCT Filed: Sep. 16, 2010
(86) PCT No.: PCT/IT10/00393

§ 371 Date: Mar. 14, 2013

(51) Int. Cl. B29D 99/00

(52) U.S. Cl. CPC B29D 99/0092
USPC 156/212; 156/267

(57) ABSTRACT

A method and system for manufacturing saddles is provided. At least one covering sheet on an upper face of a hull is arranged and interposed between the face and the surface of the sheet in contact therewith an adhesive substance. Inside a hermetic chamber, provided with an elastically deformable membrane, arranged downstream of a nozzle for dispensing pressurized fluid, the hull is arranged, surmounted by the covering sheet, below the membrane. The chamber is closed, isolating it from the outside environment, and the fluid is introduce until a pressure is reached, upstream of the membrane. The pressure is maintained inside the chamber between 1 second and 10 minutes. The fluid is removed and the chamber is opened, removing the component constituted by the hull stably covered with the covering sheet. The edges of the sheet that protrude from the contour of the hull are trimmed.

### TECHNICAL FIELD

The present invention relates to a method for manufacturing saddles and the like: the expression “saddles and the like” is to be understood as referencing all types of saddle.

By way of example, mention is made of saddles for cycles (including tricycles, rickshaws, tandems and the like), for motorcycles (including three-wheel trucks and special vehicles even for sports use) and for vehicles of any kind, such as snowmobiles, water scooters, watercraft (consider the fighting chairs used in open sea fishing and/or the driving consoles of certain types of boat), quadricycles and the like.

However, the possibility is not excluded to apply the method according to the invention for manufacturing saddles for horse riding and/or saddles for training machines (such as the apparatuses and benches used in gyms and in sports centers).

### BACKGROUND ART

All saddles of the known type are constituted generally by a shell, generally made of substantially rigid material (which has structural purposes), optionally covered with appropriate layers of hide and/or fabric and/or polymer sheets in order to improve their appearance and comfort.

It is stressed that a lamina made of expanded material can be interposed between the shell and the covering in order to make the saddle softer.

The manufacture of a saddle that conforms to the described characteristics provides for the arrangement of the covering layer over the shell, its tensioning for optimal covering of the shell itself and the locking of its edges, after folding them under the edge of the shell, toward its lower surface, by means of staples or rivets (generically, a manual process of tacking or seaming).

Since this is a manual method, it is clear that the quality of the finished product will depend on the skill of the operator and it will be therefore very difficult to ensure a constant quality standard.

At the same time, if yielding materials are used (such as hide, imitation leather and some types of fabric), the stability of the covering of the finished product depends on the tension imposed by the operator during assembly: obviously, an incorrect tensioning of the material will cause the formation of creases on the saddle after a certain number of hours of use.

It must be stressed, furthermore, that saddles provided according to this type of manual method require particular care during maintenance: washing, for example, cannot be performed by using high-pressure washers or particularly powerful jets of water, because they might lift a flap of the covering material, forming a triggering point for the complete separation thereof.

It is not irrelevant, moreover, that saddles provided by means of known types of method can be covered effectively and with quality only if they have a substantially regular shape: any irregularity causes a significant increase in covering difficulty, which leads to an increase in costs that is often not justifiable from the point of view of the buyer.

### Disclosure of the Invention

The aim of the present invention is to solve the problems described above, by proposing a method for manufacturing saddles and the like of the industrialized type in order to ensure the constancy of the characteristics of the finished products obtained therewith.

Within this aim, an object of the invention is to propose a method for manufacturing saddles and the like that ensures optimal strength and stability of the finished products even if they are subjected to onerous and prolonged use.

Another object of the invention is to propose a method for manufacturing saddles and the like that is predominantly automated in order to reduce production costs.

Another object of the present invention is to provide a method for manufacturing saddles and the like that is relatively easy to provide and safe in use.

This aim and these and other objects that will become better apparent hereinafter are achieved by a method for manufacturing saddles and the like, which consists in arranging at least one covering sheet on the upper face of a hull, also called shell, of a saddle, interposing between said face and the surface of the sheet in contact therewith an adhesive substance; inside a hermetic chamber, provided with an elastically deformable membrane, arranged downstream of a nozzle for dispensing pressurized fluid, arranging the hull, surmounted by said covering sheet, substantially below said membrane; closing the chamber, isolating it from the outside environment; introducing the pressurized fluid until a pressure is reached, upstream of said membrane, which is comprised between 0.1 and 20 bar, i.e., comprised between 10 KPa and 2 MPa; maintaining the pressure value indicated in the previous step inside the chamber for a time comprised between 1 second and 10 minutes; removing the pressurized fluid, opening the chamber and removing the component constituted by the hull stably covered with said covering sheet; trimming the edges of said sheet that protrude from the contour of said hull by removing them by means of a sharp tool, obtaining the finished saddle.

### BRIEF DESCRIPTION OF THE DRAWINGS

Further characteristics and advantages of the invention will become better apparent from the detailed description that follows of a preferred but not exclusive embodiment of the method for manufacturing saddles and the like according to the invention, illustrated by way of non-limiting example in the accompanying drawings, wherein:

FIG. 1 is a schematic view of an initial step of the method for manufacturing saddles and the like according to the invention;

FIG. 2 is a schematic view of an advanced step of the method for manufacturing saddles and the like according to the invention;

FIG. 3 is a schematic view of a chamber for manufacturing saddles and the like for using the method according to the invention;

FIG. 4 is a schematic view of a saddle obtained with the method according to the invention.

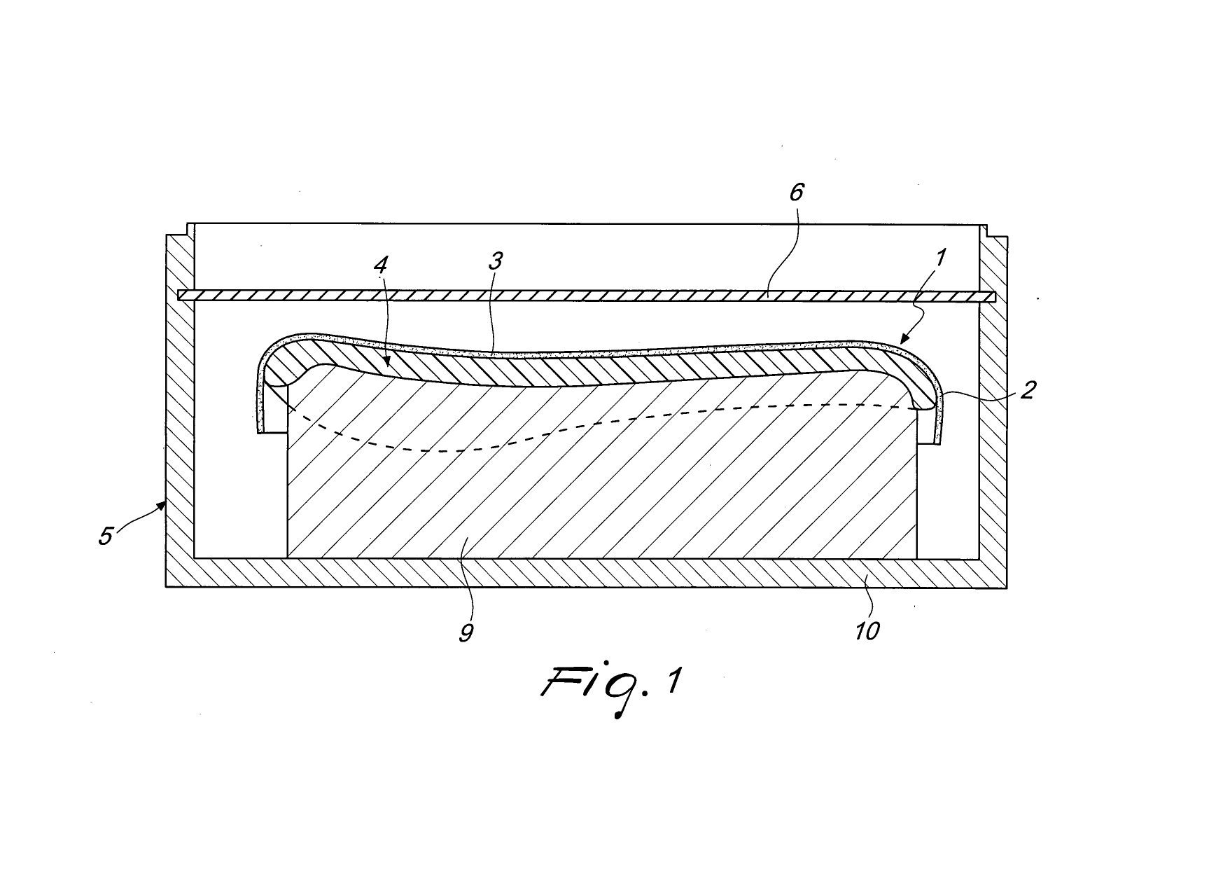

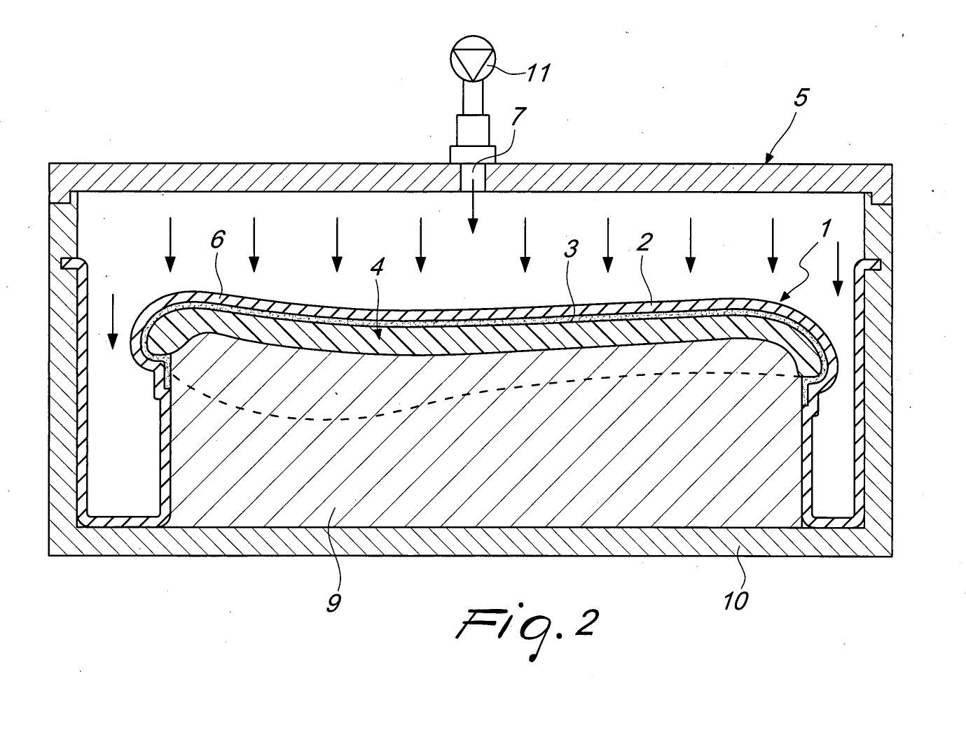

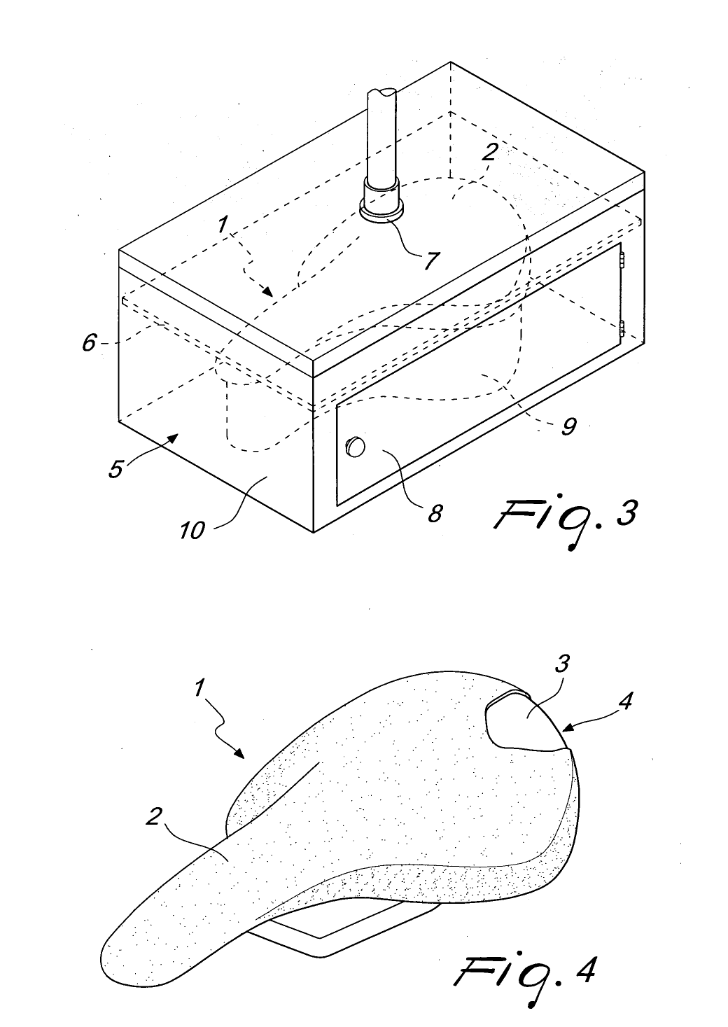

### WAYS OF CARRYING OUT THE INVENTION

With reference to the figures, a saddle provided by using the method according to the invention is generally designated by the reference numeral 1. The method according to the invention consists in performing a series of consecutive steps.

A first step a) provides for the deposition/placement (the most correct term is juxtaposition) of at least one covering sheet 2 on the upper face 3 of a hull 4, also known as shell, of a saddle.

The juxtaposition occurs after the interposition, preferably with an even distribution, of an adhesive substance between the face 3 and the surface of the sheet 2 in contact with it.

A second step b) is instead performed inside a hermetic chamber 5, which is provided with an elastically deformable membrane 6.

The membrane 6 is arranged downstream of a nozzle 7 adapted to deliver pressurized fluid.

Step b) requires the arrangement of the hull 4, surmounted by the respective covering sheet 2, inside the chamber 5 (which for this purpose comprises an access door 8): the hull 4 and the covering 2 are arranged substantially below the membrane 6, preferably resting on a respective support.

In a third step c) it is necessary to close the chamber 5 (by closing the door 8 hermetically), isolating it from the outside environment.

A fourth step d) requires the introduction of pressurized fluid until a pressure is reached through the nozzle 7, upstream to the membrane 6, which is comprised between 0.1 bar and 20 bar, i.e., comprised (by using the units of measurement used in the International System) between 10 KPa and 2 MPa.

During a fifth step e) it is necessary to maintain the pressure value indicated in step d) inside the chamber 5 for a time comprised between 1 second and 10 minutes.

A sixth step f) requires the removal of the pressurized fluid, the opening of the chamber 5 and the removal of the component constituted by the hull 4, stably covered with the covering sheet 2: the hull 4 and the covering 2 are, already at this point, stably cohesive because the adhesive (subjected to the indicated pressure) has already had the opportunity to cross-link effectively.

A seventh and last step g) consists in trimming, by removing them by means of a sharp tool, the edges of the sheet 2 that protrude from the contour of the hull 4, obtaining the finished saddle 1.

According to a possible applicative variation of the method according to the invention, the first step a) provides for subjecting to a preventive treatment at least one surface chosen between the upper face 3 of the hull 4 and the surface of the covering sheet 2.

The preventive treatment consists in arranging a grip promoting agent, usually known as “primer”, on such at least one surface, in order to facilitate the correct and stable adhesion thereon of the adhesive substance.

According to one particular embodiment of unquestionable interest in practice and in application, the adhesive substance is a polychloroprene, a type of polymer also known as “neoprene”.

Moreover, it is of noteworthy importance, in order to optimize the efficiency and production performance of the method according to the invention, that the pressurized fluid introduced in the chamber 5 has a temperature comprised between 10° C. and 100° C.: the use of a specific temperature for the pressurized fluid introduced in the chamber 5 may contribute to accelerate and increase the strength of the bond, in particular because it facilitates the fast and complete evaporation of the solvents present within the adhesive substance.

In order to improve the aesthetic appearance of the saddle 1 and make it conform to particular production requirements, at the end of the seventh step g) it may be convenient to subject the covering sheet 2, appropriately trimmed, to at least one treatment chosen between coloring and spraying with waxy substances.

While the coloring has a mainly esthetic function, the surface treatment with waxes (in particular with sheets 2 made of hide and similar materials) ensures greater resistance to external agents and makes the material waterproof.

According to a particular application of the method according to the invention that has proved itself to be productively efficient and stable, the pressure of the fluid introduced in the chamber 5 during step d) is preferably comprised between 2 and 8 bar, i.e., comprised between 200 KPa and 800 KPa.

In this case it must be noted that the time interval during which the pressurized fluid must persist inside the chamber 5 should be comprised preferably between 10 seconds and 20 seconds.

Also, the fact should not be overlooked that according to this particular applicative variation of the method the temperature of the pressurized fluid introduced in the chamber 5 must be comprised preferably between 20° C. and 40° C.

In order to provide a saddle 1 that is particularly comfortable and thus has a soft resting surface, during step a) it is appropriate to also interpose a second laminar element made of expanded material. Optionally, the second sheet may be also integrated in the first sheet 2: the use of multilayer sheets 2 in fact might speed up the application of the method according to the invention, because a single multilayer sheet 2 will have already the characteristics required of the finished product.

In this case (covering with multilayer sheet 2) it might be preferable to use sheets 2 constituted by sheets made of a material of the type of hide, imitation leather, fabric, polymers and .the like between which a layer made of expanded material is interposed which has the function of increasing softness.

According to this embodiment and if the various sheets are superimposed at the time of application of the method (i.e., one does not have a multilayer sheet 2), the adhesive substance must be interposed and distributed between the face 3 of the hull 4 and a first surface of the laminar element made of expanded material in contact with it and between the surface of the covering sheet 2 and the other surface of the laminar element made of expanded material in contact with it.

In practice, the adhesive substance (and also the optional pre-treatments with grip promoting agents and primers) must be distributed on all the facing surfaces of different sheets, as well as on the face 3 of the hull 4.

The pressurized fluid may be simple air, but in more demanding applications the use of other different fluids, such as also oils, water, specific gas mixtures and specific liquid mixtures, is not excluded.

The chamber 5 is constituted by a hermetic box-like body 10, which is provided with at least one opening, which can be closed hermetically (by means of the door 8), for inserting semi-finished products inside it.

The box-like body 10 comprises the elastically deformable membrane 6 arranged proximate to its upper face.

The upper face, in turn, is provided with a seat for the hermetic accommodation of the nozzle 7 for introducing pressurized fluid, which is connected to a respective supply circuit (generally connected to a pump or compressor 11).

According to a particular embodiment of unquestionable interest in practice and in application, the supply circuit is a pneumatic circuit (in this case it will comprise, therefore, a compressor 11).

It is specified that the membrane 6 is made of a material of the type of an elastomer, which is therefore adapted to undergo high deformations in the elastic range: the introduction of pressurized fluid thus deforms the membrane 6 until it mates with the hull 4 (compressing the covering sheet 2 on the face 3 thereof).

This condition of mutual high pressure facilitates the perfect and steady adhesive bonding of the surfaces in contact. The saddle 1 comprises a hull 4, also known as shell, which is substantially rigid and is covered by means of at least one covering sheet 2.

In particular, the at least one covering sheet 2 is stably glued, even with the interposition of further shock-absorbing layers, to the hull 4 up to the perimetric edges of the hull 4. There are no rivets, staples made of metal (or of another kind) and fixing staples in order to couple the sheet 2 stably to the hull 4; the perfect cohesion of the sheet 2 to the hull 4 is entrusted solely to the adhesive substance.

It is noted that according to possible embodiments that are particularly interesting from a practical and applicative point of view, the hull 4 is made preferably of a material chosen among metallic materials, composite materials, polymeric materials and wood.

Likewise, the at least one covering sheet 2 is preferably made of a material chosen among hide, fabric, polymeric materials, rubber and natural fibers.

It is noted that the method according to the invention,. particularly . when it is applied by using a chamber 5 of the type of the one described previously, is particularly suitable for providing saddles for cycles and motorcycles, saddles for any means of transport (snowmobiles, water scooters, wheelhouses for watercraft and others), saddles for horse riding; however, the use of this method for manufacturing saddles for gym machines, training benches and the like is not excluded.

Advantageously, the method for manufacturing saddles 1 and the like according to the invention solves the typical problems of this type of products, allowing a production of the industrialized type (no longer manual, as for traditional saddles) in order to ensure constancy of the characteristics of the finished products obtained therewith.

Conveniently, the method for manufacturing saddles 1 and the like ensures optimal resistance and stability of the finished products even if they are subjected to onerous use extended over time: nailed or sewn coverings may easily be damaged by use and by washing and maintenance operations.

Positively, the method according to the invention is of the predominantly automated type, reducing in practice the production costs.

The invention thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the dimensions, may be any according to requirements and to the state of the art.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-15. (canceled)

16. A method for manufacturing saddles and the like, the method comprising the steps of:
a) arranging at least one covering sheet on an upper face of a hull of a saddle, interposing between the face and a surface of the sheet in contact therewith an adhesive substance;
b) inside a hermetic chamber, provided with an elastically deformable membrane, arranged downstream of a nozzle for dispensing pressurized fluid, arranging the hull, surmounted by the covering sheet, substantially below the membrane;
c) closing the chamber, isolating it from the outside environment;
d) introducing the pressurized fluid until a pressure is reached, upstream of the membrane, which is comprised between 0.1 and 20 bar, i.e., comprised between 10 KPa and 2 MPa;
e) maintaining the pressure value indicated in step d) inside the chamber for a time comprised between 1 second and 10 minutes;
f) removing the pressurized fluid, opening the chamber and removing the component constituted by the hull stably covered with the covering sheet; and
g) trimming the edges of the sheet that protrude from the contour of the hull by removing them by means of a sharp tool, obtaining the finished saddle.

17. The method according to claim 16, further comprising, during the step a), exposing to a preventive treatment at least one surface chosen between the upper face of the hull and the surface of the covering sheet, the preventive treatment comprising the placement of a grip promoting agent, usually termed primer, on the at least one surface, in order to facilitate the correct and stable adhesion of the adhesive substance.

18. The method according to claim 16, wherein the adhesive substance is a polychloroprene, a type of polymers also known as neoprene.

19. The method according to claim 16, wherein the pressurized fluid introduced in the chamber has a temperature comprised between 10° C. and 100° C.

20. The method according to claim 16, further comprising, during step g), subjecting the covering sheet, appropriately trimmed, to at least one treatment between coloring and spraying with waxy substances.

21. The method according to claim 16, wherein the pressure of the fluid introduced in the chamber during step d) is comprised between between 200 KPa and 800 KPa.

22. The method according to claim 16, wherein a time interval during which the pressurized fluid persists inside the chamber is comprised between 10 and 20 seconds.

23. The method according to claim 19, wherein a temperature of the pressurized fluid introduced in the chamber is comprised between 20° C. and 40° C.

24. The method according to claim 16, further comprising, during the step a), interposing also a second laminar element made of expanded material, the adhesive substance being interposed and distributed between the face of the hull and a first surface of the laminar element made of expanded material in contact with it and between the surface of the covering sheet and the other surface of the laminar element made of expanded material in contact with it.

25. A chamber for manufacturing saddles and the like, the chamber comprising:
a hermetic box-like body provided with at least one opening, which can be closed hermetically, in order to insert semi-finished products inside it, the hermetic box-like body comprising an elastically deformable membrane arranged proximate to its upper face, which is provided with a seat for the hermetic accommodation of a nozzle, for introducing the pressurized fluid, which is connected to a respective supply circuit.

26. The chamber according to claim 25, wherein the supply circuit is a pneumatic circuit.

27. The chamber according to claim 25, wherein the membrane is made of a material of the type of an elastomer type, which is therefore adapted to be subjected to high deformations in the elastic range.

28. A saddle comprising:
a hull which is substantially rigid and covered by at least one covering sheet, wherein the at least one covering sheet is stably glued, with the interposition of further shock-absorbing layers, to the hull up to the perimetric edges of the hull.

29. The saddle according to claim 28, wherein the hull is made of a material chosen among metallic materials, composite materials, polymeric materials and wood.

30. The saddle according to claim 28, wherein the at least one covering sheet is made of a material chosen among hide, fabric, polymeric materials, rubber and natural fibers.
